(19) United States
(12) Patent Application Publication
(10) Pub. No.: US 2022/0415072 A1
(43) Pub. Date: Dec. 29, 2022

(54) IMAGE PROCESSING METHOD, TEXT RECOGNITION METHOD AND APPARATUS

(71) Applicant: Beijing Baidu Netcom Science Technology Co., Ltd., Beijing (CN)

(72) Inventor: Jingtuo LIU, Beijing (CN)

(21) Appl. No.: 17/901,897

(22) Filed: Sep. 2, 2022

(30) Foreign Application Priority Data
Feb. 25, 2022 (CN) 2022101823373

(51) Int. Cl. G06V 30/412; G06V 30/413

(52) U.S. Cl. CPC G06V 30/412; G06V 30/413

(57) ABSTRACT

The present disclosure provides an image processing method, a text recognition method and an apparatus. The image processing method includes: preprocessing acquired sample images to obtain position information, image blocks and text content corresponding to fields in the sample images respectively; making a mask prediction on the position information of the fields according to the position information, the image blocks and the text content corresponding to the fields respectively to obtain a prediction result; and training according to the prediction result to obtain a text recognition model, where the text recognition model is used to perform text recognition on a to-be-recognized image.

### CROSS-REFERENCES TO RELATED APPLICATIONS

This application claims priority to Chinese patent application No. 202210182337.3, filed on Feb. 25, 2022 and entitled “IMAGE PROCESSING METHOD, TEXT RECOGNITION METHOD AND APPARATUS”. The content of the above application is hereby incorporated by reference in its entirety.

### TECHNICAL FIELD

The present disclosure relates to the field of artificial intelligence technology, in particular to the field of deep learning and computer vision technologies, can be applied to scenarios such as optical character recognition (OCR), and in particular relates to an image processing method, a text recognition method and an apparatus.

### BACKGROUND

With development of artificial intelligence (AI) technology, network models are widely applied in various fields, such as training a text recognition model to recognize characters in an image based on the text recognition model, so as to obtain text content, etc.

In the related art, annotated sample images are usually used to train a basic network model, so that the basic network model can learn the ability to recognize text content in the sample images, thereby obtaining the text recognition model.

However, with the above method, there is a technical problem that the reliability of the text recognition model is low.

### SUMMARY

The present disclosure provides an image processing method, a text recognition method and an apparatus.

According to a first aspect of the present disclosure, an image processing method is provided, including:

preprocessing acquired sample images to obtain position information, image blocks and text content corresponding to fields in the sample images respectively;

making a mask prediction on the position information of the fields according to the position information, the image blocks and the text content corresponding to the fields respectively to obtain a prediction result; and

training according to the prediction result to obtain a text recognition model, where the text recognition model is used to perform text recognition on a to-be-recognized image.

According to a second aspect of the present disclosure, a text recognition method is provided, including:

acquiring a to-be-recognized image; and

performing text recognition on the to-be-recognized image based on a pre-trained text recognition model to obtain text content of the to-be-recognized image;

where the text recognition model is obtained based on the method according to the first aspect.

According to a third aspect of the present disclosure, an image processing apparatus is provided, including:

at least one processor; and

a memory communicatively connected to the at least one processor; where,

the memory stores instructions executable by the at least one processor, and the at least one processor is configured to:

preprocess acquired sample images to obtain position information, image blocks and text content corresponding to fields in the sample images respectively;

make a mask prediction on the position information of the fields according to the position information, the image blocks and the text content corresponding to the fields respectively to obtain a prediction result; and

train according to the prediction result to obtain a text recognition model, where the text recognition model is used to perform text recognition on a to-be-recognized image.

According to a fourth aspect of the present disclosure, a text recognition apparatus is provided, including:

at least one processor; and

a memory communicatively connected to the at least one processor; where,

the memory stores instructions executable by the at least one processor, and the at least one processor is configured to:

acquire a to-be-recognized image; and

perform text recognition on the to-be-recognized image based on a pre-trained text recognition model to obtain text content of the to-be-recognized image;

where the text recognition model is trained based on the method according to the first aspect.

According to a fifth aspect of the present disclosure, a non-transitory computer readable storage medium having computer instructions stored thereon is provided, where the computer instructions are used to cause a computer to execute the method according to the first aspect or the second aspect.

It should be understood that the content described in this section is not intended to identify essential or important features of embodiments of the present disclosure, nor is it intended to limit the scope of the present disclosure. Other features of the present disclosure will be readily understood by the following description.

### BRIEF DESCRIPTION OF DRAWINGS

The accompanying drawings are for a better understanding of the solutions and do not constitute a limitation to the present disclosure.

FIG. 1 is a diagram of a scenario that can implement an image processing method and a text recognition method according to embodiments of the present disclosure.

FIG. 2 is a schematic diagram according to a first embodiment of the present disclosure.

FIG. 3 is a schematic diagram according to a second embodiment of the present disclosure.

FIG. 4 is a schematic diagram according to a third embodiment of the present disclosure.

FIG. 5 is a principle schematic diagram 1 according to the present disclosure.

FIG. 6 is a principle schematic diagram 2 according to the present disclosure.

FIG. 7 is a schematic diagram according to a fourth embodiment of the present disclosure.

FIG. 8 is a schematic diagram according to a fifth embodiment of the present disclosure.

FIG. 9 is a schematic diagram according to a sixth embodiment of the present disclosure.

FIG. 10 is a schematic diagram according to a seventh embodiment of the present disclosure.

FIG. 11 is a schematic diagram according to an eighth embodiment of the present disclosure.

FIG. 12 is a schematic diagram according to a ninth embodiment of the present disclosure.

FIG. 13 is a schematic diagram according to a tenth embodiment of the present disclosure.

FIG. 14 is a block diagram of an electronic device for implementing an image processing method and a text recognition method according to embodiments of the present disclosure.

### DESCRIPTION OF EMBODIMENTS

Exemplary embodiments of the present disclosure are described below in conjunction with accompanying drawings, including various details of the embodiments of the present disclosure for ease of understanding, which should be considered merely exemplary. Therefore, those skilled in the art should recognize that various changes and modifications of the embodiments described herein can be made without departing from the scope and spirit of the present disclosure. Similarly, for the sake of clarity and conciseness, the description of well-known functions and structures is omitted from the following description.

Document image structuring refers to extracting text content (referring to all character information in an image) and essential information (referring to part of information that is concerned and can be determined based on requirements) in the image, and digitizing and structuring content in the image.

Accordingly, text structured information may be understood as text structured information obtained by document image structuring, that is, text content.

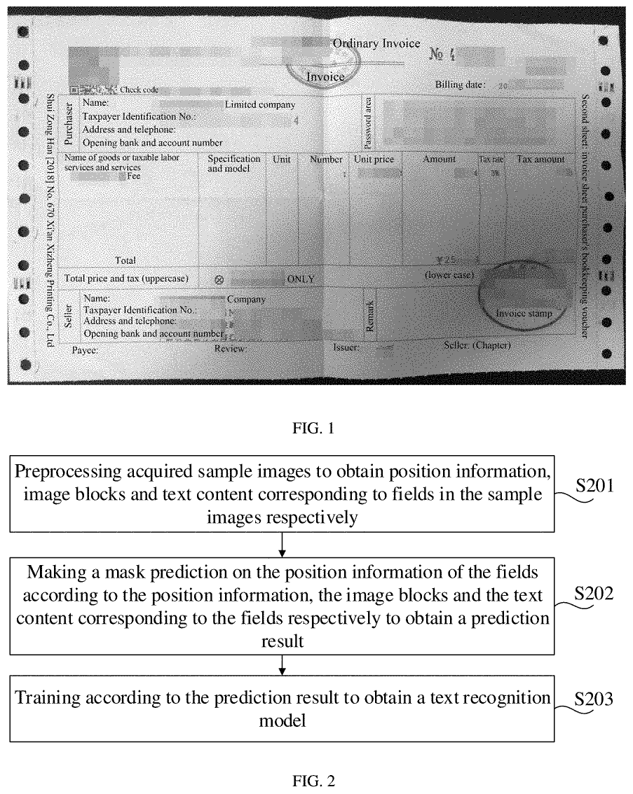

For example, if the document image structuring is performed for an invoice as shown in FIG. 1, the invoice as shown in FIG. 1 may be photographed to obtain an invoice image, so as to extract information such as invoice number, amount and date in the invoice image.

It should be understood that FIG. 1 is only used to illustrate a possible form of a document image, and should not be construed as a limitation on the document image. The document image may be understood as an image including text content, such as a train ticket image, or a signboard image.

Document image structuring may be understood as a process of acquiring text content in an image including the text content. With the development of artificial intelligence technology, it can be implemented based on a network model, such as training a text recognition model to perform character recognition on a to-be-recognized image based on the text recognition model, so as to obtain text content in the to-be-recognized image.

In some embodiments, a basic network model may be trained based on sample images to obtain the text recognition model.

For example, for different application scenarios, sample images (including text content) corresponding to the application scenarios are selected and annotated, and the basic network models are trained based on the annotated sample images, so as to obtain the text recognition models.

Combined with the above analysis, text recognition models in different application scenarios may be used to detect text content of different types of document images. For example, for an application scenario of an invoice, when training the text recognition model for recognizing an invoice image, sample invoice images are acquired and annotated, and a basic network model is trained based on the annotated sample invoice images, so as to obtain the text recognition model for recognizing a to-be-recognized image which is an invoice image.

For another example, for an application scenario of a ticket, when training the text recognition model for recognizing an ticket image, sample ticket images are acquired and annotated, and a basic network model is trained based on the annotated sample ticket images, so as to obtain the text recognition model for recognizing a to-be-recognized image which is a ticket image.

However, based on this method, for different application scenarios, it is necessary to specially collect the sample images of corresponding application scenarios for training after annotation, resulting in large amount of annotation, long training time and low universality.

In other embodiments, the text recognition model may be obtained by training in a way of “pre-training+fine-tuning”.

The “pre-training” may be understood as, generating a pre-training model based on sample images without distinguishing application scenarios, and its essence may be understood as a hidden layer. The “fine-tuning” may be understood as, training to obtain a text recognition model suitable for an application scenario on the basis of the hidden layer and in combination with the application scenario.

Exemplarily, combined with the above analysis, the training of the text recognition model may include two stages, one is a “pre-training” stage, and the other is a “fine-tuning” stage. For the application scenario of invoice and the application scenario of ticket, a hidden layer that may be shared by the two application scenarios can be obtained based on the “pre-training” stage. In the “fine-tuning” stage, for the application scenario of invoice, a text recognition model suitable for the application scenario of invoice can be obtained by training in combination with sample invoice images and the hidden layer. For the application scenario of ticket, a text recognition model suitable for the ticket application scenario can be obtained by training in combination with sample ticket images and the hidden layer.

In one example, the “pre-training” may be completed based on a masked visual-language model (MVLM).

For example, part of characters in a sample image may be masked based on a masked visual language model, that is, part of the characters in the sample image are covered, and the covered part of the characters may be restored according to an uncovered part of the characters in the sample image.

Specifically, the covered part of the characters may be determined based on the context of the uncovered part of the characters in the sample image. When covering part of the characters in the sample image, the text itself of part of the characters and an area where the covered part of the characters in the sample image are located may be covered.

In another example, the “pre-training” may be completed by using a way of text length prediction.

For example, a visual feature of a sample image may be acquired, a character length of text content in the sample image may be predicted according to the visual feature, and the “pre-training” may be completed based on the predicted character length and a real character length (pre-annotated).

In another example, the “pre-training” may be completed based on position information between fields.

For example, visual features corresponding to different fields (such as two fields) of a sample image may be acquired, and a position relationship of different fields may be predicted based on the visual features, so as to complete the “pre-training” with the predicted position relationship of different fields.

In another example, part of text in a sample image may be covered, and word-level binary classification may be performed on an output of part of the text to predict whether each word is covered, and the “pre-training” may be completed based on a prediction result.

In another example, partial image of a sample image may be replaced or discarded to obtain a negative sample, and whether text content in the sample image matches text content in the partial image may be predicted based on a binary classification, so as to complete the “pre-training” based on a prediction result.

However, combined with the above analysis, when using the above methods to complete the “pre-training”, they usually start from a dimension of a text feature, and fused features in the sample image are relatively not comprehensive. Therefore, there may be a problem that the reliability and accuracy of the “pre-training” are low.

In order to avoid at least one of the above problems, the inventor of the present disclosure acquired an inventive concept of the present disclosure through creative effort: completing “pre-training” in combination with features of multiple dimensions of a sample image, and obtaining a text recognition model through “fine-tuning”.

Based on the above inventive concept, the present disclosure provides an image processing method, a text recognition method and an apparatus for improving the reliability of image processing, which are applied in the field of artificial intelligence technology, in particular to the field of deep learning and computer vision technologies, and can be applied to scenarios such as OCR, thereby improving the efficiency and reliability of training.

FIG. 2 is a schematic diagram according to a first embodiment of the present disclosure. As shown in FIG. 2, an image processing method of this embodiment includes the following steps.

S201: preprocessing acquired sample images to obtain position information, image blocks and text content corresponding to fields in the sample images respectively.

Exemplarily, an executive entity of this embodiment may be an image processing apparatus, and the image processing apparatus may be a server (such as a cloud server, or a local server, or a server cluster), a computer, a terminal device, a processor, a chip, etc., which is not limited in this embodiment.

This embodiment does not limit the way of preprocessing which, for example, can be implemented by using character detection technology or character recognition technology.

This step may be understood as: acquiring a sample image, where the sample image includes a field, that is, the sample image includes characters; and preprocessing the field to obtain the position information of the field (such as pixel coordinates of the characters), the image block of the field (such as a rectangular box used to frame the field), and the text content of the field (that is, text content of the sample image).

S202 making a mask prediction on the position information of the fields according to the position information, the image blocks and the text content corresponding to the fields respectively to obtain a prediction result.

The mask prediction refers to performing mask processing on the position information of the field and predicting the position information before the mask.

In this embodiment, the mask prediction made by combining content of three dimensions (i.e. the position information, the image block and the text content corresponding to the field respectively) can make the mask prediction have high reliability, and improve the accuracy of the mask prediction. Furthermore, when training in combination with the prediction result to obtain a text recognition model, the text recognition model can have high accuracy and reliability.

S203: training according to the prediction result to obtain a text recognition model.

The text recognition model is used to perform text recognition on a to-be-recognized image.

In combination with the above embodiment, S201-S202 may be understood as the “pre-training” stage, and S203 may be understood as the “fine-tuning” stage.

It can be seen based on the above analysis that, the present disclosure provides an image processing method, including: preprocessing the acquired sample images to obtain the position information, the image blocks and the text content corresponding to the fields in the sample images respectively; making the mask prediction on the position information of the fields according to the position information, the image blocks and the text content corresponding to the fields respectively to obtain the prediction result; and training according to the prediction result to obtain the text recognition model, where the text recognition model is used to perform text recognition on a to-be-recognized image. In this embodiment, through the technical features of making the mask prediction on the position information of the fields by combing the position information, the image blocks and the text content corresponding to the fields respectively to complete “pre-training”, and training based on the prediction result of the “pre-training” to obtain the text recognition model, since content of multiple dimensions of the sample images is fused for “pre-training”, the “pre-training” can have high comprehensiveness and reliability, so that when the text recognition model is generated based on the prediction result (that is, “fine-tuning” is completed), the text recognition model can have high accuracy and reliability, and then when text recognition is performed based on the text recognition model, the accuracy of the text recognition can be improved.

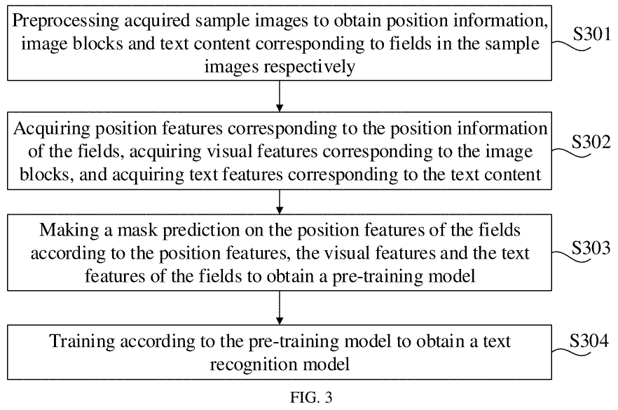

FIG. 3 is a schematic diagram according to a second embodiment of the present disclosure. As shown in FIG. 3, an image processing method of this embodiment includes the following steps.

S301: preprocessing acquired sample images to obtain position information, image blocks and text content corresponding to fields in the sample images respectively.

It should be understood that, in order to avoid cumbersome statements, the same technical features of this embodiment as those of the above embodiments will not be repeated in this embodiment.

S302: acquiring position features corresponding to the position information of the fields, acquiring visual features corresponding to the image blocks, and acquiring text features corresponding to the text content.

This embodiment does not limit a manner of acquiring the features of above three dimensions which, for example, may be implemented by a model or an algorithm.

A position feature may be a feature vector representing the field in a pixel coordinate dimension in the sample image, a visual feature may be a feature vector representing the field in a visual dimension (such as color and texture), and a text feature may be a feature vector representing the field in a character feature dimension (such as stoke and structure).

S303 making a mask prediction on the position features of the fields according to the position features, the visual features and the text features of the fields to obtain the pre-training model.

That is, the prediction result may be the pre-training model. According to the above analysis, the prediction result is essentially a hidden layer.

In this embodiment, since features of three dimensions can relatively strongly express features of the sample image, when making the mask prediction on the position feature of the fields in combination with the features of three dimensions, the mask prediction can be made with high accuracy and reliability.

In some embodiments, S303 may include the following steps.

The first step: randomly removing parts of the position features of the fields.

A process of model training is an iterative training process. In some embodiments, a removal ratio may be set based on a requirement, a history record, and an experiment, etc., to randomly remove part of a position feature of a field based on the removal ratio. In other embodiments, part of the position feature of the field may also be removed based on different removal ratios.

The second step making the mask prediction on removed parts of the position features of the fields according to the visual features, the text features and retained parts of the position features of the fields to obtain the pre-training model.

In this embodiment, part of a position feature is removed in a way of random removal, so that the pre-training model can restore different position features, and thus the pre-training model has high accuracy and reliability. And the mask prediction is made on the removed part of the position feature by combining the features of three dimensions that have not been removed, so that the mask prediction can restore the removed part of the position feature from a pixel coordinate dimension, and can also restore the removed part of the position feature from a text content dimension, and can also restore the removed part of the position feature from a character visual dimension, so that the restored part of the position feature is highly identical to the removed part of the position feature.

In some embodiments, the second step may include the following sub-steps.

The first sub-step: making a prediction according to the visual features, the text features and the retained parts of the position features of the fields to obtain the removed parts of the position features of the fields.

In combination with the above analysis, in this embodiment, the removed part of the position feature is obtained by prediction through the features of three dimensions that have not been removed. An association relationship between the removed part of the position feature and the retained part of the position feature on the pixel coordinates, an association relationship between context-based semantics, and an association relationship between visual context are considered, so that the removed part of the position feature which is obtained by prediction has high accuracy and reliability.

The second sub-step: acquiring position information corresponding to the removed parts of the position features of the fields.

The third sub-step: generating the pre-training model according to the position information of the fields and acquired position information.

Exemplarily, this embodiment may be understood as that, the position information corresponding to the removed part of the position feature is obtained by prediction according to the retained features of the three dimensions, so as to generate the pre-training model based on the position information before removal and the position information after removal.

In some embodiments, a loss function between the position information of the field and the acquired position information may be calculated, and the pre-training model may be obtained by training based on the loss function.

The loss function is used to represent difference information between the position information of the field and the acquired position information. In other words, the pre-training model is generated by combining the difference information between the position information before removal and the position information after removal, so as to make the generated pre-training model targeted and improve convergence speed of generating the pre-training model.

S304: training according to the pre-training model to obtain a text recognition model.

The text recognition model is used to perform text recognition on a to-be-recognized image.

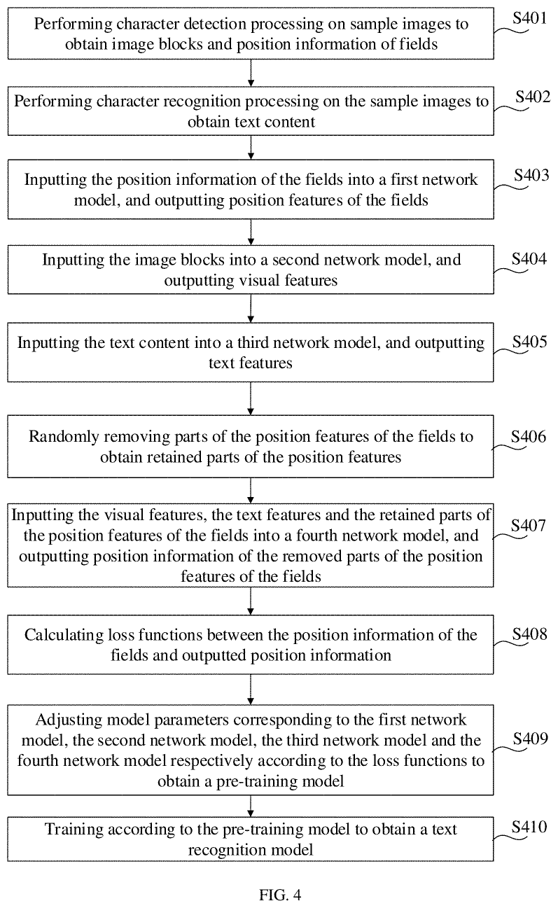

FIG. 4 is a schematic diagram according to a third embodiment of the present disclosure. As shown in FIG. 4, an image processing method of this embodiment includes the following steps.

S401: performing character detection processing on sample images to obtain image blocks and position information of fields.

An image block is a bounding box used to frame an area corresponding to position information of a field.

Similarly, in order to avoid cumbersome statements, the same technical features of this embodiment as those of the above embodiments will not be repeated in this embodiment.

In other words, a sample image may be preprocessed based on the character detection technology to obtain an image block of the sample image in the visual dimension and position information of the sample image in the position.

S402: performing character recognition processing on the sample images to obtain text content.

In other words, the sample image may be preprocessed with character recognition technology to obtain the text content of the sample image.

Exemplarily, it can be seen from FIG. 5 that, the preprocessing includes the character detection processing and the character recognition processing. The character detection processing is performed on the sample image to obtain the image block and the position information, and the character recognition processing is performed on the sample image to obtain the text content.

In this embodiment, the sample image is preprocessed through different preprocessing methods (i.e., character detection processing and character recognition processing) to obtain content of different dimensions of the sample image, so as to improve the flexibility and diversity of preprocessing the sample image.

S403: inputting the position information of the fields into a first network model, and outputting the position features of the fields.

Exemplarily, as shown in FIG. 5, an output of the first network model is the position feature.

S404: inputting the image blocks into a second network model, and outputting the visual features.

S405: inputting the text content into a third network model, and outputting the text features.

This embodiment does not limit network frameworks, structures and parameters of the first network model, the second network model and the third network model. For implementation principles of extracting respective features based on the network models, please refer to the related art, which is not limited in this embodiment.

In this embodiment, the features of the three dimensions of the sample image are determined in parallel, which can avoid interference between features and improve the efficiency and accuracy of determining the features.

S406: randomly removing parts of the position features of the fields to obtain retained parts of the position features.

Exemplarily, as shown in FIG. 5, random position feature removal is performed on the position feature outputted by the first network model, the visual feature outputted by the second network model and the text feature outputted by the third network model to obtain the retained features.

The retained features include the visual feature outputted by the second network model, the text feature outputted by the third network model, and position information that is not randomly removed in the position feature outputted by the first network model.

S407: inputting the visual features, the text features and the retained parts of the position features of the fields into a fourth network model, and outputting position information of the removed parts of the position features of the fields.

Similarly, this embodiment does not limit the fourth network model.

Exemplarily, as shown in FIG. 5, the retained features (including the visual feature, the text feature, and the retained part of the position feature of the field) are inputted into the fourth network model, and the position information of the position feature removed by the random position feature removal is obtained by prediction.

Similarly, in this embodiment, the position information of the position feature removed by the random position feature removal is obtained by prediction in combination with features of the three dimensions, so that the predicted position information can have high accuracy and reliability, that is, the position information corresponding to the removed position feature can be restored relatively accurately.

S408: calculating loss functions between the position information of the fields and outputted position information.

Exemplarily, as shown in FIG. 5, a loss function between the position information obtained by the character detection processing and the position information obtained by prediction by the fourth network model is calculated.

The loss function may include a distance loss between the position information of the field and the outputted position information.

Exemplarily, the distance loss between the position information of the field and the outputted position information may be calculated, and the distance loss may be determined as the loss function.

In combination with the above analysis, in this embodiment, the pre-training model is obtained by mask prediction on the position features, therefore, by determining the distance losses as the loss functions, the loss functions can be targeted to characterize the difference information between the position information before and after the mask processing, so that when the pre-training model is generated in combination with the distance loss functions, the reliability and accuracy of the pre-training model can be improved.

In some embodiments, the position information of the field includes a detected abscissa and a detected ordinate of the field based on a pixel coordinate system; the outputted position information includes a predicted abscissa and a predicted ordinate of the field based on the pixel coordinate system. The calculating of the distance loss may include the following steps.

The first step: calculating abscissa difference information between the predicted abscissa and the detected abscissa, and ordinate difference information between the predicted ordinate and the detected ordinate.

The second step: determining the distance loss according to the abscissa difference information and the ordinate difference information.

For example, the position information may be represented by pixel coordinates (x1, y1, x2, y2), where (x1, y1) are upper left corner coordinates of the position information and (x2, y2) are lower right corner coordinates of the position information. Of course, the position information may also be represented in other forms, such as (x, y, w, h) and so on.

Among them, x, x1 and x2 are abscissas, y, y1 and y2 are ordinates, w is width and h is height.

If the position information is represented by pixel coordinates (x1, y1, x2, y2), in some embodiments, a distance loss L1 may be determined according to Equation 1. Equation 1:

L1=|x₁^{p}−x₁^{g}|+|x₂^{p}−x₂^{g}|+|y₁^{p}−y₁^{g}|+|y₂^{p}−y₂^{g}|.

In other embodiments, a distance loss L2 may be determined according to Equation 2. Equation 2:

L2=(x₁^{p}−x₁^{g})²+(x₂^{p}−x₂^{g})²+(y₁^{p}−y₁^{g})²+(y₂^{p}−y₂^{g})².

The superscript p is the predicted abscissa and the superscript g is the detected abscissa (i.e. a true value).

In this embodiment, by determining the distance loss from two dimensions (i.e. abscissa difference information and ordinate difference information), the distance loss can be determined globally, so that the determined distance loss has high comprehensiveness and reliability.

S409: adjusting respective model parameters corresponding to the first network model, the second network model, the third network model and the fourth network model according to the loss functions to obtain the pre-training model.

In this embodiment, the first network model, the second network model, the third network model and the fourth network model are taken as an overall network model, and the overall network model is trained in combination with the loss functions, so that the network models are combined closely with each other, thereby reducing errors.

S410: training according to the pre-training model to obtain a text recognition model.

The text recognition model is used to perform text recognition on a to-be-recognized image.

This step may be understood as a “fine-tuning” stage.

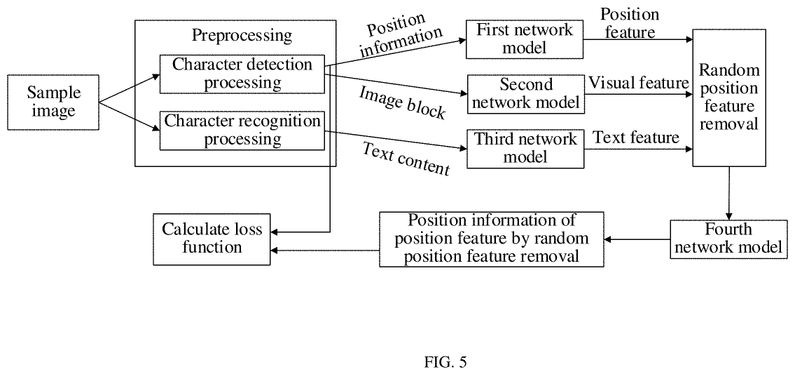

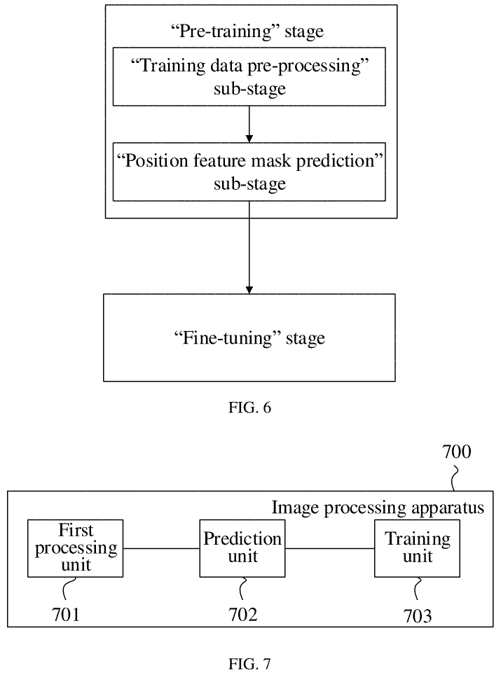

That is, as shown in FIG. 6, in this embodiment, obtaining the text recognition model by training includes two stages, one is a “pre-training” stage, see S401-S409 for details, and the other is the “fine-tuning” stage, see S410 for details.

As shown in FIG. 6, the “pre-training” stage may include two sub-stages. One is a “training data pre-processing” sub-stage, see S401-S402 for details, where the sample image is training data; and the other is a “position feature mask prediction” sub-stage, see S403-S409 for details.

The pre-training model obtained after the “pre-training” stage is a general model for different application scenarios, or for different types of recognition requirements, and for different application scenarios, or different types of recognition requirements, targeted training can be performed on the basis of the general model, so as to obtain a final neural network model applied to a corresponding application scenario, for example, a neural network model for text recognition of an invoice or a neural network model for contract recognition.

Further training can be made using annotated training data based on the pre-training model, so as to obtain the final neural network model applied to the corresponding application scenario.

Accordingly, text structured information (i.e. text content) of the to-be-recognized image can be outputted based on the final neural network model applied to the corresponding application scenario.

FIG. 7 is a schematic diagram of a fourth embodiment of the present disclosure. As shown in FIG. 7, an image processing apparatus 700 of this embodiment includes:

a first processing unit 701, configured to preprocess acquired sample images to obtain position information, image blocks and text content corresponding to fields in the sample images respectively;

a prediction unit 702, configured to make a mask prediction on the position information of the fields according to the position information, the image blocks and the text content corresponding to the fields respectively to obtain a prediction result; and

a training unit 703, configured to train according to the prediction result to obtain a text recognition model, where the text recognition model is used to perform text recognition on a to-be-recognized image.

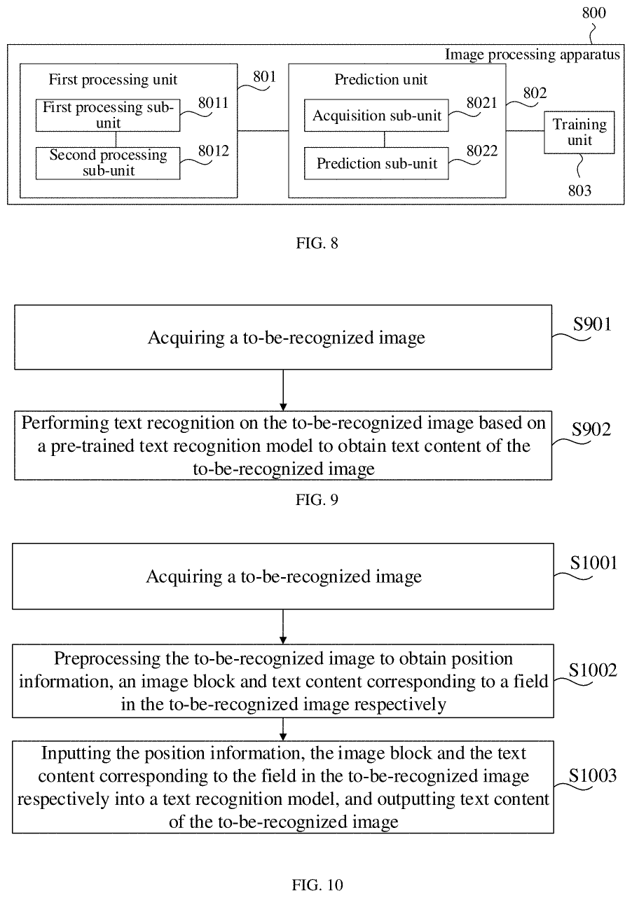

FIG. 8 is a schematic diagram of a fifth embodiment of the present disclosure. As shown in FIG. 8, an image processing apparatus 800 of this embodiment includes the following units.

A first processing unit 801 is configured to preprocess acquired sample images to obtain position information, image blocks and text content corresponding to fields in the sample images respectively.

In some embodiments, the preprocessing includes character detection processing and character recognition processing. Referring to FIG. 8, the first processing unit 801 includes:

a first processing sub-unit 8011, configured to perform the character detection processing on the sample images to obtain the image blocks and the position information of the fields, where the image blocks are bounding boxes used to frame areas corresponding to the position information of the fields; and

a second processing sub-unit 8012, configured to perform the character recognition processing on the sample images to obtain the text content.

A prediction unit 802 is configured to make a mask prediction on the position information of the fields according to the position information, the image blocks and the text content corresponding to the fields respectively to obtain a prediction result.

It can be seen from FIG. 8 that in some embodiments, the prediction result is a pre-training model. The prediction unit 802 includes the following sub-units.

An acquisition sub-unit 8021 is configured to acquire position features corresponding to the position information of the fields, acquire visual features corresponding to the image blocks, and acquire text features corresponding to the text content.

In some embodiments, the acquisition sub-unit 8021 includes:

a first input module, configured to input the position information of the fields into a first network model;

a first output module, configured to output the position features corresponding to the position information of the fields;

a second input module, configured to input the image blocks into a second network model;

a second output module, configured to output the visual features;

a third input module, configured to input the text content into a third network model; and

a third output module, configured to output the text features.

A prediction sub-unit 8022 is configured to make the mask prediction on the position features of the fields according to the position features, the visual features and the text features of the fields to obtain the pre-training model.

In some embodiments, the prediction sub-unit 8022 includes:

a removal module, configured to randomly remove parts of the position features of the fields; and

a prediction module, configured to make the mask prediction on removed parts of the position features of the fields according to the visual features, the text features and retained parts of the position features of the fields to obtain the pre-training model.

In some embodiments, the prediction module includes:

an input sub-module, configured to input the visual features, the text features and the retained parts of the position features of the fields into a fourth network model;

an output sub-module, configured to output position information of the removed parts of the position features of the fields; and

a second generation sub-module, configured to generate the pre-training model according to the position information of the fields and outputted position information.

In some embodiments, the second generation sub-module is configured to calculate loss functions between the position information of the fields and outputted position information, and adjust respective model parameters corresponding to the first network model, the second network model, the third network model and the fourth network model according to the loss functions to obtain the pre-training model.

In some embodiments, the second generation sub-module is configured to calculate distance losses between the position information of the fields and the outputted position information, and determine the distance losses as the loss functions.

In some embodiments, the position information of the fields include detected abscissas and detected ordinates of the fields based on a pixel coordinate system; the outputted position information includes predicted abscissas and predicted ordinates of the fields based on the pixel coordinate system. The second generation sub-module is configured to calculate abscissa difference information between the predicted abscissas and the detected abscissas, and ordinate difference information between the predicted ordinates and the detected ordinates, and determine the distance losses according to the abscissa difference information and the ordinate difference information.

In some embodiments, the prediction module includes:

a prediction sub-module, configured to obtain the removed parts of the position features of the fields by prediction according to the visual features, the text features and the retained parts of the position features of the fields;

an acquisition sub-module, configured to acquire position information corresponding to the removed parts of the position features of the fields; and

a first generation sub-module, configured to generate the pre-training model according to the position information of the fields and acquired position information.

In some embodiments, the first generation sub-module is configured to calculate loss functions between the position information of the fields and the acquired position information, and train based on the loss functions to obtain the pre-training model.

A training unit 803 is configured to train according to the prediction result to obtain a text recognition model, where the text recognition model is used to perform text recognition on a to-be-recognized image.

FIG. 9 is a schematic diagram according to a sixth embodiment of the present disclosure. As shown in FIG. 9, a text recognition method of this embodiment includes the following steps.

S901: acquiring a to-be-recognized image.

Exemplarily, an executive entity of this embodiment may be a text recognition apparatus, and the text recognition apparatus and the image processing apparatus in the above embodiment may be the same apparatus or different apparatuses, which is not limited in this embodiment.

The acquiring of the to-be-recognized image may be implemented using the following examples.

In one example, the text recognition apparatus may be connected to an image collection apparatus and receive an image sent by the image acquisition apparatus.

The image acquisition apparatus may be an apparatus with a function of image collection, such as a camera.

In another example, the text recognition apparatus may provide a tool for loading an image, and a user may transmit the to-be-recognized image to the text recognition apparatus through the tool for loading the image.

The tool for loading the image may be an interface for connecting with an external device, such as an interface for connecting with other storage devices, through which the to-be-recognized image transmitted by the external device is obtained. The tool for loading the image may also be a display apparatus. For example, the text recognition apparatus may input an interface with a loading image function on the display apparatus. The user may import the to-be-recognized image to the text recognition apparatus through this interface, and the text recognition apparatus acquires the imported to-be-recognized image.

S902: performing text recognition on the to-be-recognized image based on a pre-trained text recognition model to obtain text content of the to-be-recognized image.

The text recognition model is obtained based on the image processing method according to any of the above embodiments.

FIG. 10 is a schematic diagram according to a seventh embodiment of the present disclosure. As shown in FIG. 10, a text recognition method of this embodiment includes the following steps.

S1001: acquiring a to-be-recognized image.

Similarly, in order to avoid cumbersome statements, the same technical features of this embodiment as those of the above embodiments will not be repeated in this embodiment.

S1002: preprocessing the to-be-recognized image to obtain position information, an image block and text content corresponding to a field in the to-be-recognized image respectively.

Similarly, combined with the above analysis, the preprocessing may include character detection processing and character recognition processing. S1002 may include the following steps.

The first step: performing character detection processing on the to-be-recognized image to obtain the image block and the position information corresponding to the field in the to-be-recognized image.

The image block corresponding to the field in the to-be-recognized image is a bounding box used to frame an area corresponding to the position information of the field in the to-be-recognized image.

The second step: performing character recognition processing on the to-be-recognized image to obtain the text content corresponding to the to-be-recognized image.

S1003: inputting the position information, the image block and the text content corresponding to the field in the to-be-recognized image respectively into a text recognition model, and outputting text content of the to-be-recognized image.

The text recognition model is obtained based on the image processing method according to any of the above embodiments.

FIG. 11 is a schematic diagram of an eighth embodiment of the present disclosure. As shown in FIG. 11, a text recognition apparatus 1100 of this embodiment includes:

an acquisition unit 1101, configured to acquire a to-be-recognized image; and

a recognition unit 1102, configured to perform text recognition on the to-be-recognized image based on a pre-trained text recognition model to obtain text content of the to-be-recognized image;

where the text recognition model is obtained based on the image processing method according to any of the above embodiments.

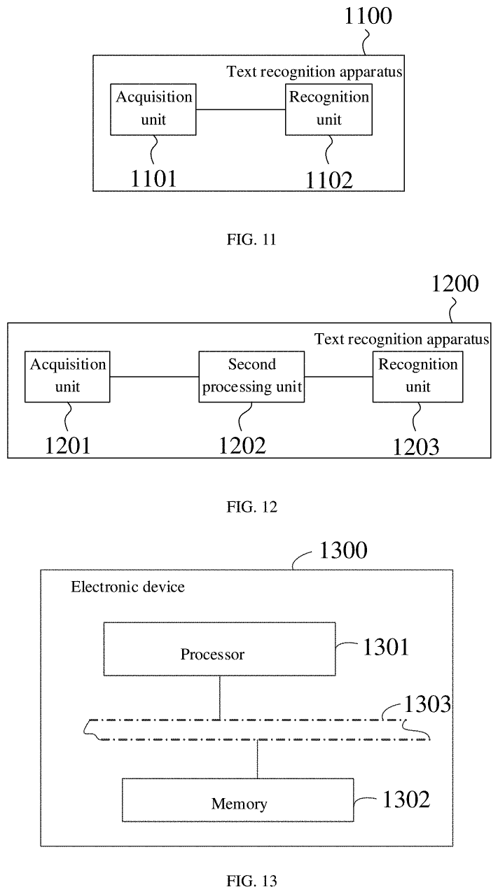

FIG. 12 is a schematic diagram according to a ninth embodiment of the present disclosure. As shown in FIG. 12, a text recognition apparatus 1200 of this embodiment includes:

an acquisition unit 1201, configured to acquire a to-be-recognized image.

a second processing unit 1202, configured to preprocess the to-be-recognized image to obtain position information, an image block, and text content corresponding to a field in the to-be-recognized image respectively; and

a recognition unit 1203, configured to input the position information, the image block and the text content corresponding to the field in the to-be-recognized image respectively into a text recognition model, and output text content of the to-be-recognized image.

The text recognition model is obtained based on the image processing method according to any of the above embodiments.

FIG. 13 is a schematic diagram according to a tenth embodiment of the present disclosure. As shown in FIG. 13, an electronic device 1300 in the present disclosure may include a processor 1301 and a memory 1302.

The memory 1302 is used to store a program. The memory 1302 may include a volatile memory, such as a random-access memory (RAM), a static random access memory (SRAM), a double data rate synchronous dynamic random access memory (DDR SDRAM), etc. The memory may also include a non-volatile memory, such as a flash memory. The memory 1302 is used to store a computer program (such as an application program, functional modules and the like for implementing the above methods), computer instructions and so on, and the above computer program, computer instructions and so on may be stored in one or more memories 1302 in partitions. The above computer program, computer instructions, data and so on may be called by the processor 1301.

The processor 1301 is configured to execute the computer program stored in the memory 1302 to implement the steps of the methods involved in the above described embodiments.

For details, please refer to the relevant description in the previous method embodiments.

The processor 1301 and the memory 1302 may be independent structures, or may be integrated together to form an integrated structure. When the processor 1301 and the memory 1302 are independent structures, the memory 1302 and the processor 1301 may be coupled through a bus 1303.

The electronic device of this embodiment may execute the technical solutions of the above methods, and specific implementation processes and technical principles are the same, and will not be repeated here.

In the technical solutions of the present disclosure, collection, storage, use, processing, transmission, provision, disclosure and others of a user's personal information involved comply with the provisions of relevant laws and regulations, and do not violate public order and good customs.

According to embodiments of the present disclosure, the present disclosure also provides an electronic device, a readable storage medium and a computer program product.

According to an embodiment of the present disclosure, the present disclosure also provides a computer program product. The computer program product includes a computer program which is stored in a readable storage medium, and at least one processor of an electronic device can read the computer program from the readable storage medium. The at least one processor executes the computer program to cause the electronic device to execute the solution according to any of the above embodiments.

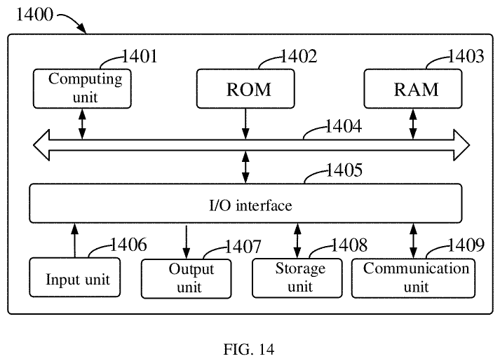

FIG. 14 shows a schematic block diagram of an example electronic device 1400 that can be used to implement embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing devices. The components, their connections and relationships, and their functions shown herein are merely examples and are not intended to limit the implementation of the present disclosure described and/or claimed herein.

As shown in FIG. 14, the device 1400 includes a computing unit 1401 that may perform various appropriate actions and processing according to a computer program stored in a read only memory (ROM) 1402 or loaded from a storage unit 1408 into a random access memory (RAM) 1403. In the RAM 1403, various programs and data necessary for operations of the device 1400 may also be stored. The computing unit 1401, the ROM 1402 and the RAM 1403 are connected to each other through a bus 1404. An input/output (I/O) interface 1405 is also connected to the bus 1404.

A plurality of components in the device 1400 are connected to the I/O interface 1405, including: an input unit 1406, such as a keyboard, a mouse, etc.; an output unit 1407, such as various types of displays, speakers, etc.; the storage unit 1408, such as a magnetic disk, an optical disc, etc.; and a communication unit 1409, such as a network card, a modem, a wireless communication transceiver, etc. The communication unit 1409 allows the device 1400 to exchange information/data with other devices through a computer network such as the Internet and/or various telecommunication networks.

The computing unit 1401 may be various general-purpose and/or special-purpose processing components with processing and computing capabilities. Some examples of the computing unit 1401 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1401 executes various methods and processing described above, such as an image processing method, a text recognition method. For example, in some embodiments, the image processing method and the text recognition method may be implemented as a computer software program tangibly embodied in a machine-readable medium, such as the storage unit 1408. In some embodiments, part or all of the computer program may be loaded and/or installed on the device 1400 via the ROM 1402 and/or the communication unit 1409. When the computer program is loaded into the RAM 1403 and executed by the computing unit 1401, one or more steps of the image processing method and the text recognition method described above may be performed. Alternatively, in other embodiments, the computing unit 1401 may be configured to execute the image processing method and the text recognition method by any other suitable means (for example, by means of firmware).

Various implementations of systems and techniques described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. These various implementations may include: being implemented in one or more computer programs, where the one or more computer programs may be executed and/or interpreted on a programmable system including at least one programmable processor, and the programmable processor may be a special-purpose or general-purpose programmable processor, and may receive data and instructions from a storage system, at least one input apparatus and at least one output apparatus, and transmit data and instructions to the storage system, the at least one input apparatus and the at least one output apparatus.

Program codes for implementing the methods of the present disclosure may be written in any combination of one or more programming languages. These program codes may be provided to a processor or a controller of a general-purpose computer, a special-purpose computer or other programmable data processing apparatuses, so that the program codes, when executed by the processor or the controller, enable functions/operations specified in the flowcharts and/or the block diagrams to be implemented. The program code may be entirely executed on the machine, partially executed on the machine, partially executed on the machine and partially executed on a remote machine as a separate software package, or entirely executed on a remote machine or a server.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine readable medium may include, but is not limited to, an electronic, magnetic, optical, electromagnetic, infrared or semiconductor system, apparatus or device, or any suitable combination of the foregoing. More specific examples of the machine-readable storage medium may include one or more wire-based electrical connections, a portable computer disk, a hard disk, a random access memory (RAM), a read only memory (ROM), an erasable programmable read only memory (EPROM or flash memory), an optical fiber, a compact disk read only memory (CD-ROM), an optical storage device, a magnetic storage device, or any suitable combination of the foregoing.

In order to provide interaction with a user, the systems and techniques described herein may be implemented on a computer, and the computer has: a display apparatus (e. g., a CRT (cathode ray tube) or LCD (liquid crystal display) monitor) for displaying information to the user; and a keyboard and a pointing apparatus (e. g., a mouse or a trackball), through which the user can provide input to the computer. Other kinds of apparatuses may also be used to provide interaction with the user; for example, a feedback provided to the user may be any form of sensor feedback (e. g., a visual feedback, an auditory feedback, or a tactile feedback); and an input from the user may be received in any form (including an acoustic input, a voice input or a tactile input).

The systems and techniques described herein may be implemented in a computing system including a back-end component (e. g., as a data server), or a computing system including a middleware component (e. g., an application server), or a computing system including a front-end component (e. g., a user computer having a graphical user interface or a web browser through which a user may interact with implementations of the systems and techniques described herein), or a computing system including any combination of such back-end component, middleware component or front-end component. The components of the system may be interconnected in any form or medium of digital data communication (e. g., a communication network). Examples of the communication network include local area networks (LAN), wide area networks (WAN), and the Internet.

A computer system may include a client and a server. The client and server are generally far away from each other and usually interact through a communication network. A relationship of client and server is generated by computer programs running on corresponding computers and having a client-server relationship with each other. The server may be a cloud server, also known as a cloud computing server or a cloud host, which is a host product in a cloud computing service system to solve problems of difficult management and weak business scalability in a traditional physical host and a VPS (Virtual Private Server) service. The server may also be a server of a distributed system or a server combined with a blockchain.

It should be understood that steps may be reordered, added or deleted for various forms of processes shown above. For example, the steps recorded in the present disclosure may be performed in parallel, in sequence, or in different orders. As long as desired results of the technical solutions of the present disclosure can be achieved, no limitation is imposed herein.

The above specific embodiments do not constitute a limitation to the protection scope of the present disclosure. It should be understood by those skilled in the art that various modifications, combinations, sub-combinations and substitutions may be made according to design requirements and other factors. Any modification, equivalent replacement and improvement made within the spirit and principles of the present disclosure should be included within the protection scope of the present disclosure.

What is claimed is:

1. An image processing method, comprising:
preprocessing acquired sample images to obtain position information, image blocks and text content corresponding to fields in the sample images respectively;
making a mask prediction on the position information of the fields according to the position information, the image blocks and the text content corresponding to the fields respectively to obtain a prediction result; and
training according to the prediction result to obtain a text recognition model, wherein the text recognition model is used to perform text recognition on a to-be-recognized image.

2. The method according to claim 1, wherein the prediction result is a pre-training model;
making the mask prediction on the position information of the fields according to the position information, the image blocks and the text content corresponding to the fields respectively to obtain the prediction result comprises:
acquiring position features corresponding to the position information of the fields, acquiring visual features corresponding to the image blocks, and acquiring text features corresponding to the text content; and
making the mask prediction on the position features of the fields according to the position features, the visual features and the text features of the fields to obtain the pre-training model.

3. The method according to claim 2, wherein making the mask prediction on the position features of the fields according to the position features, the visual features and the text features of the fields to obtain the pre-training model comprises:
randomly removing parts of the position features of the fields; and
making the mask prediction on removed parts of the position features of the fields according to the visual features, the text features and retained parts of the position features of the fields to obtain the pre-training model.

4. The method according to claim 3, wherein making the mask prediction on the removed parts of the position features of the fields according to the visual features, the text features and the retained parts of the position features of the fields to obtain the pre-training model comprises:
making a prediction according to the visual features, the text features and the retained parts of the position features of the fields to obtain the removed parts of the position features of the fields;
acquiring position information corresponding to the removed parts of the position features of the fields; and
generating the pre-training model according to the position information of the fields and acquired position information.

5. The method according to claim 4, wherein generating the pre-training model according to the position information of the fields and the acquired position information comprises:
calculating loss functions between the position information of the fields and the acquired position information, and training based on the loss functions to obtain the pre-training model.

6. The method according to claim 3, wherein acquiring the position features corresponding to the position information of the fields, acquiring the visual features corresponding to the image blocks, and acquiring the text features corresponding to the text content comprises:
inputting the position information of the fields into a first network model, and outputting the position features corresponding to the position information of the fields;
inputting the image blocks into a second network model, and outputting the visual features; and
inputting the text content into a third network model, and outputting the text features.

7. The method according to claim 4, wherein acquiring the position features corresponding to the position information of the fields, acquiring the visual features corresponding to the image blocks, and acquiring the text features corresponding to the text content comprises:
inputting the position information of the fields into a first network model, and outputting the position features corresponding to the position information of the fields;
inputting the image blocks into a second network model, and outputting the visual features; and
inputting the text content into a third network model, and outputting the text features.

8. The method according to claim 5, wherein acquiring the position features corresponding to the position information of the fields, acquiring the visual features corresponding to the image blocks, and acquiring the text features corresponding to the text content comprises:
inputting the position information of the fields into a first network model, and outputting the position features corresponding to the position information of the fields;
inputting the image blocks into a second network model, and outputting the visual features; and
inputting the text content into a third network model, and outputting the text features.

9. The method according to claim 6, wherein making the mask prediction on the removed parts of the position features of the fields according to the visual features, the text features and the retained parts of the position features of the fields to obtain the pre-training model comprises:
inputting the visual features, the text features and the retained parts of the position features of the fields into a fourth network model, and outputting position information of the removed parts of the position features of the fields; and
generating the pre-training model according to the position information of the fields and outputted position information.

10. The method according to claim 9, wherein generating the pre-training model according to the position information of the fields and the outputted position information comprises:
calculating loss functions between the position information of the fields and the outputted position information; and
adjusting model parameters corresponding to the first network model, the second network model, the third network model and the fourth network model respectively according to the loss functions to obtain the pre-training model.

11. The method according to claim 10, wherein calculating the loss functions between the position information of the fields and the outputted position information comprises:
calculating distance losses between the position information of the fields and the outputted position information, and determining the distance losses as the loss functions.

12. The method according to claim 11, wherein the position information of the fields comprises detected abscissas and detected ordinates of the fields based on a pixel coordinate system; the outputted position information comprises predicted abscissas and predicted ordinates of the fields based on the pixel coordinate system;
calculating the distance losses between the position information of the fields and the outputted position information comprises:
calculating abscissa difference information between the predicted abscissas and the detected abscissas, and ordinate difference information between the predicted ordinates and the detected ordinates; and
determining the distance losses according to the abscissa difference information and the ordinate difference information.

13. The method according to claim 1, wherein the preprocessing comprises character detection processing and character recognition processing;
preprocessing the acquired sample images to obtain the position information, the image blocks and the text content corresponding to the fields in the sample images respectively comprises:
performing the character detection processing on the sample images to obtain the image blocks and the position information of the fields, wherein the image blocks are bounding boxes used to frame areas corresponding to the position information of the fields; and
performing the character recognition processing on the sample images to obtain the text content.

14. The method according to claim 2, wherein the preprocessing comprises character detection processing and character recognition processing;
preprocessing the acquired sample images to obtain the position information, the image blocks and the text content corresponding to the fields in the sample images respectively comprises:
performing the character detection processing on the sample images to obtain the image blocks and the position information of the fields, wherein the image blocks are bounding boxes used to frame areas corresponding to the position information of the fields; and
performing the character recognition processing on the sample images to obtain the text content.

15. A text recognition method, comprising:
acquiring a to-be-recognized image; and
performing text recognition on the to-be-recognized image based on a pre-trained text recognition model to obtain text content of the to-be-recognized image;
wherein the text recognition model is obtained based on the method according to claim 1.

16. The method according to claim 15, further comprising:
preprocessing the to-be-recognized image to obtain position information, an image block and text content corresponding to a field in the to-be-recognized image respectively;
wherein performing the text recognition on the to-be-recognized image based on the pre-trained text recognition model to obtain the text content of the to-be-recognized image comprises: inputting the position information, the image block and the text content corresponding to the field in the to-be-recognized image respectively into the text recognition model, and outputting the text content of the to-be-recognized image.

17. An image processing apparatus, comprising:
at least one processor; and
a memory communicatively connected to the at least one processor; wherein,
the memory stores instructions executable by the at least one processor, and the at least one processor is configured to:
preprocess acquired sample images to obtain position information, image blocks and text content corresponding to fields in the sample images respectively;
make a mask prediction on the position information of the fields according to the position information, the image blocks and the text content corresponding to the fields respectively to obtain a prediction result; and
train according to the prediction result to obtain a text recognition model, wherein the text recognition model is used to perform text recognition on a to-be-recognized image.

18. A text recognition apparatus, comprising:
at least one processor; and
a memory communicatively connected to the at least one processor; wherein,
the memory stores instructions executable by the at least one processor, and the at least one processor is configured to:
acquire a to-be-recognized image; and
perform text recognition on the to-be-recognized image based on a pre-trained text recognition model to obtain text content of the to-be-recognized image;
wherein the text recognition model is obtained based on the following steps:
preprocessing acquired sample images to obtain position information, image blocks and text content corresponding to fields in the sample images respectively;
making a mask prediction on the position information of the fields according to the position information, the image blocks and the text content corresponding to the fields respectively to obtain a prediction result; and
training according to the prediction result to obtain the text recognition model.

19. A non-transitory computer readable storage medium having computer instructions stored thereon, wherein the computer instructions are used to cause a computer to execute the method according to claim 1.

20. A non-transitory computer readable storage medium having computer instructions stored thereon, wherein the computer instructions are used to cause a computer to execute the method according to claim 15.
